(19) United States
(12) Patent Application Publication
(10) Pub. No.: US 2003/0066444 A1
(43) Pub. Date: Apr. 10, 2003

(54) Offset printing machine

(75) Inventors: Josef Hajek, Friedberg (DE); Johann Koniger, Augsburg (DE); Michael Schramm, Ainding (DE); Peter Grobner, Augsburg (DE)

Correspondence Address: COHEN, PONTANI, LIEBERMAN & PAVANE, Suite 1210, 551 Fifth Avenue, New York, NY, 10176, US

(73) Assignee: MAN Roland Druckmaschinen AG

(21) Appl. No.: 10/292,022

(22) Filed: Nov. 12, 2002

Related U.S. Application Data
(62) Division of application No. 09/657,509, filed on Sep. 7, 2000.
Application No. 09/657,509 is a division of application No. 08/386,371, filed on Feb. 9, 1995, now Pat. No. 6,408,748.

(30) Foreign Application Priority Data
Aug. 30, 1994 (DE) P 44 30 693.8

(51) Int. Cl. B41F 7/02

(52) U.S. Cl. 101/217

(57) ABSTRACT

The invention relates to the drive of a printing machine. Cylinders and functional groups are to be driven with low technical expenditure. To this end, all form cylinders (1.1, 1.2)in a printing unit, for example, are driven respectively by separate electric motors (7) and are not in mechanical drive connection.

The invention relates to drives and driving processes for cylinders and functional groups of offset printing machines.

Offset printing machines usually have a longitudinal shaft which is driven by one or more electric motors (DE 42 19 969 A1). Drive shafts, which are used to drive the printing units, unwinders, folder units and functional groups, e.g., feeding and transfer rollers, forming rollers, cutting rollers, and cooling mechanisms, branch off from the longitudinal shaft via gears and couplings. The gears usually contain further couplings and gearwheels. The drive is therefore technically complex and expensive.

The invention is based on the object of driving cylinders and functional groups in an offset printing machine with lower technical expense and creating processes and devices for this purpose.

This object is attained through the features in the independent claims. The individual motor drive makes it possible to dispense with shafts, gears, couplings and gearwheels- In addition, electrical monitoring devices for the aforementioned components are dispensed with as well.

Further advantages and features are indicated in the subclaims in conjunction with the description.

The invention is described in greater detail below in reference to several examples. The accompanying drawings show, schematically:

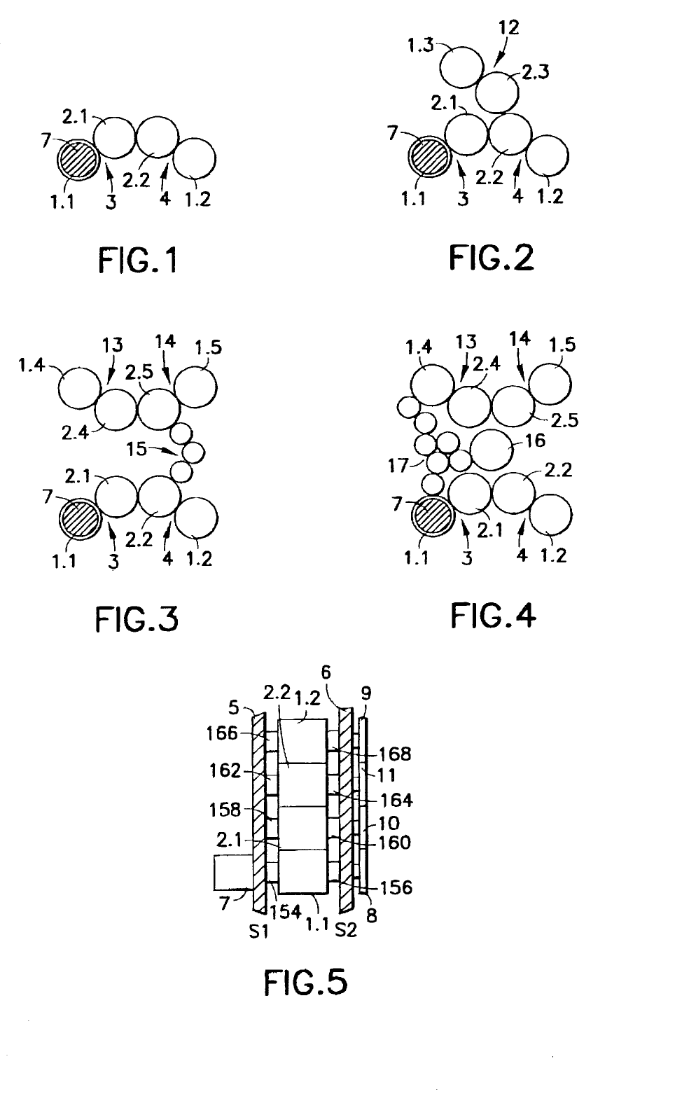

FIGS. 1 to 4 Various printing units with drives, in side view;

FIG. 5 Top view of the printing unit from FIG. 1;

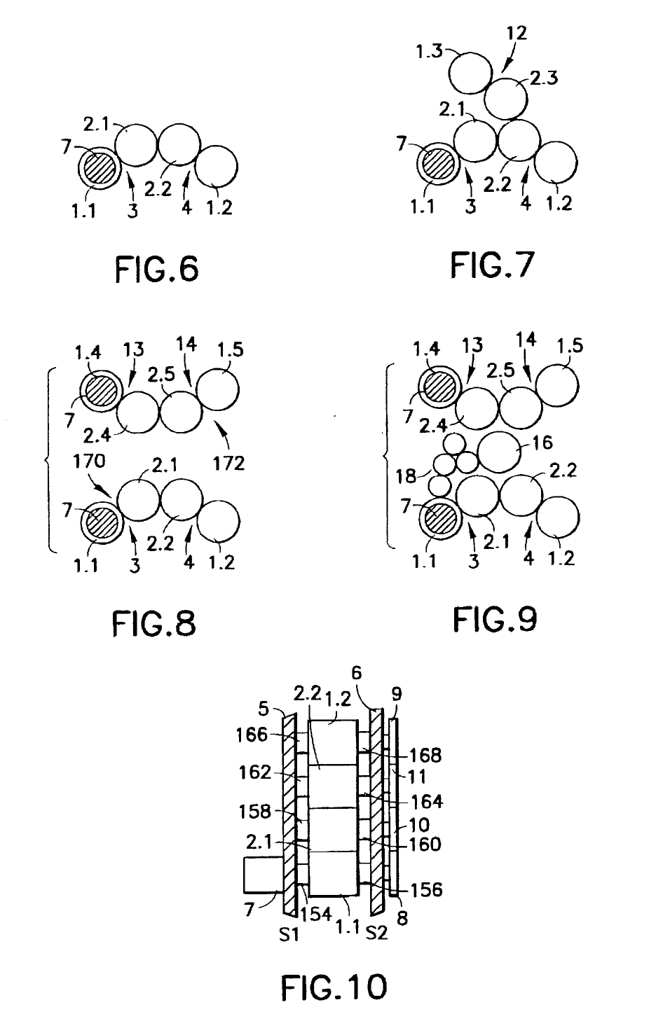

FIGS. 6 to 9 Various printing group bridges with drives;

FIG. 10 Top view of the printing group bridge from FIG. 6;

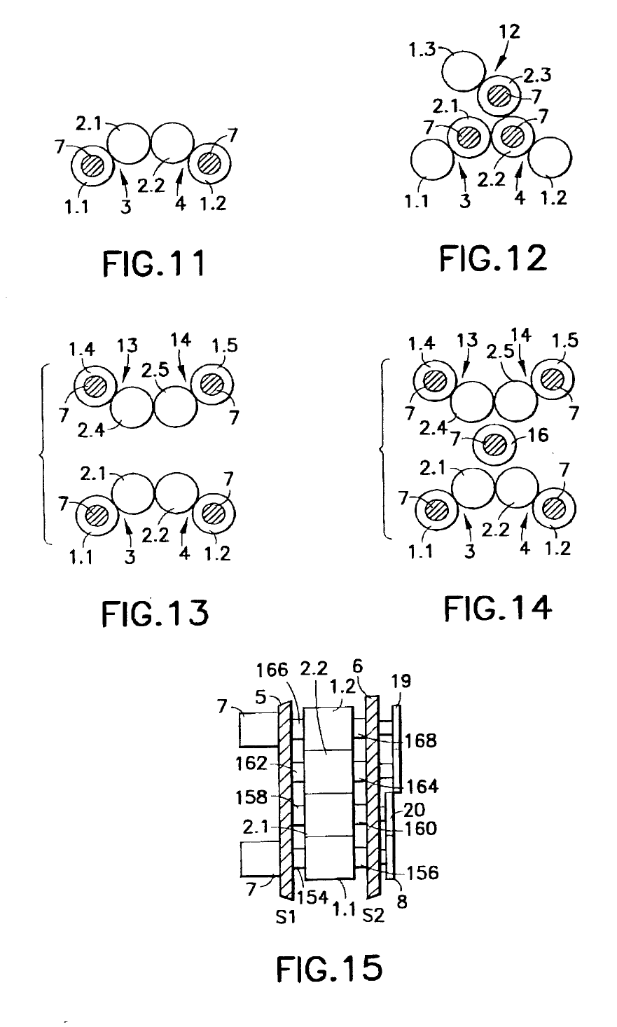

FIGS. 11 to 1 Further variants of drives; and 16 to 19

FIG. 15 Top view of the printing unit from FIG. 11;

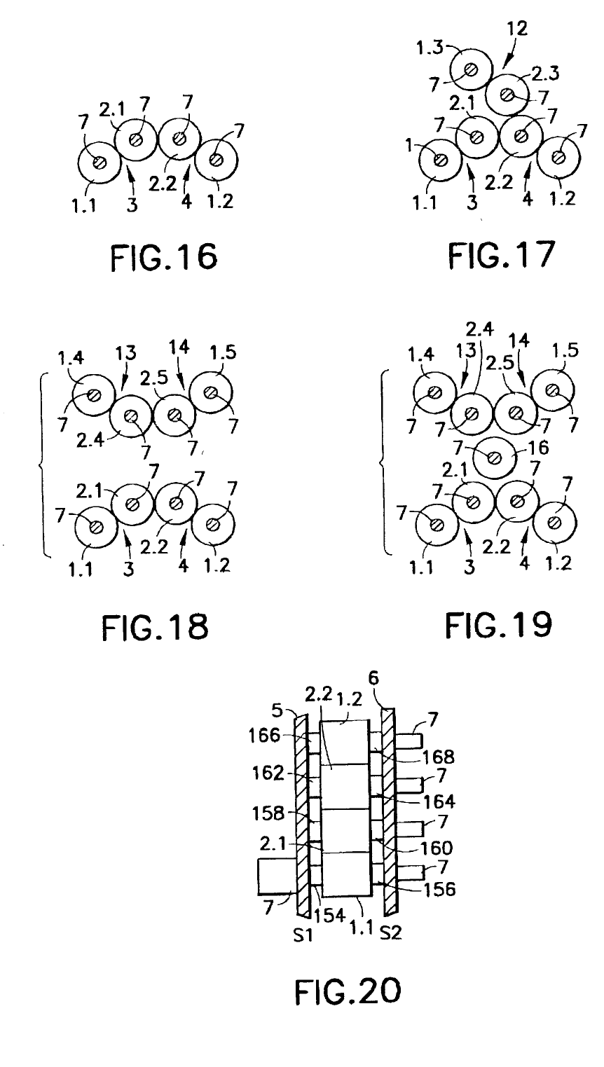

FIG. 20 Top view of the printing unit from FIG. 16;

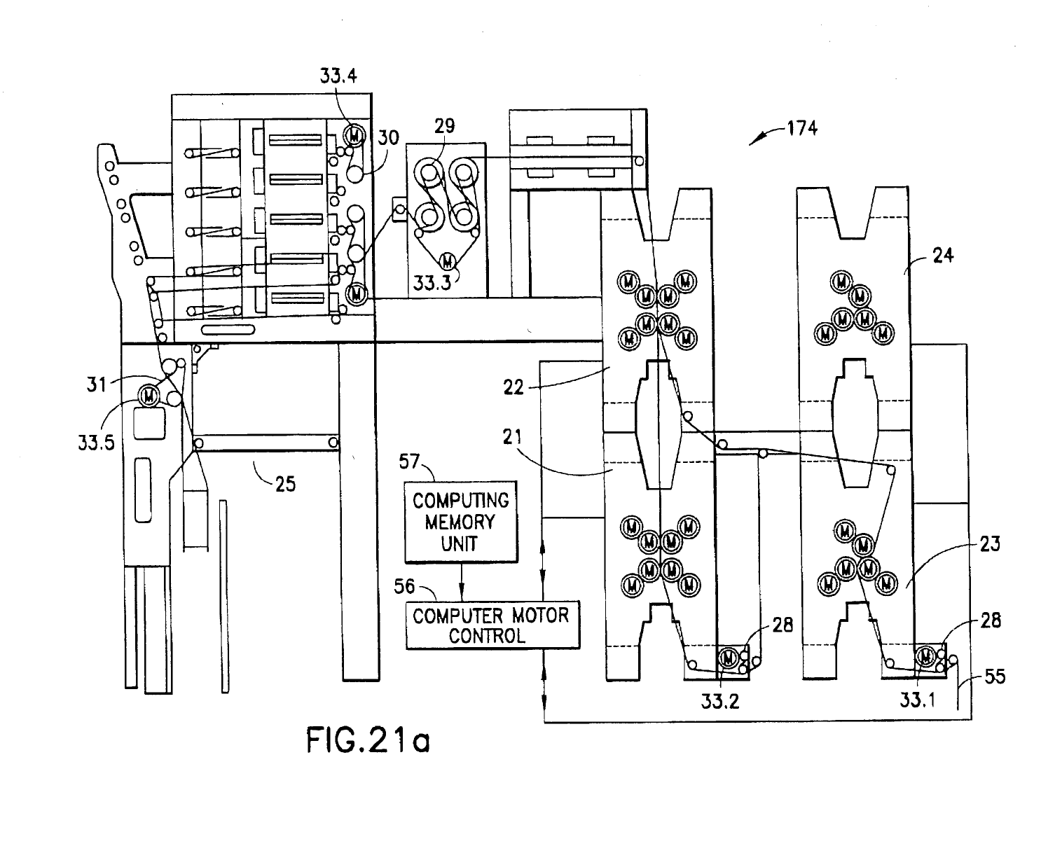

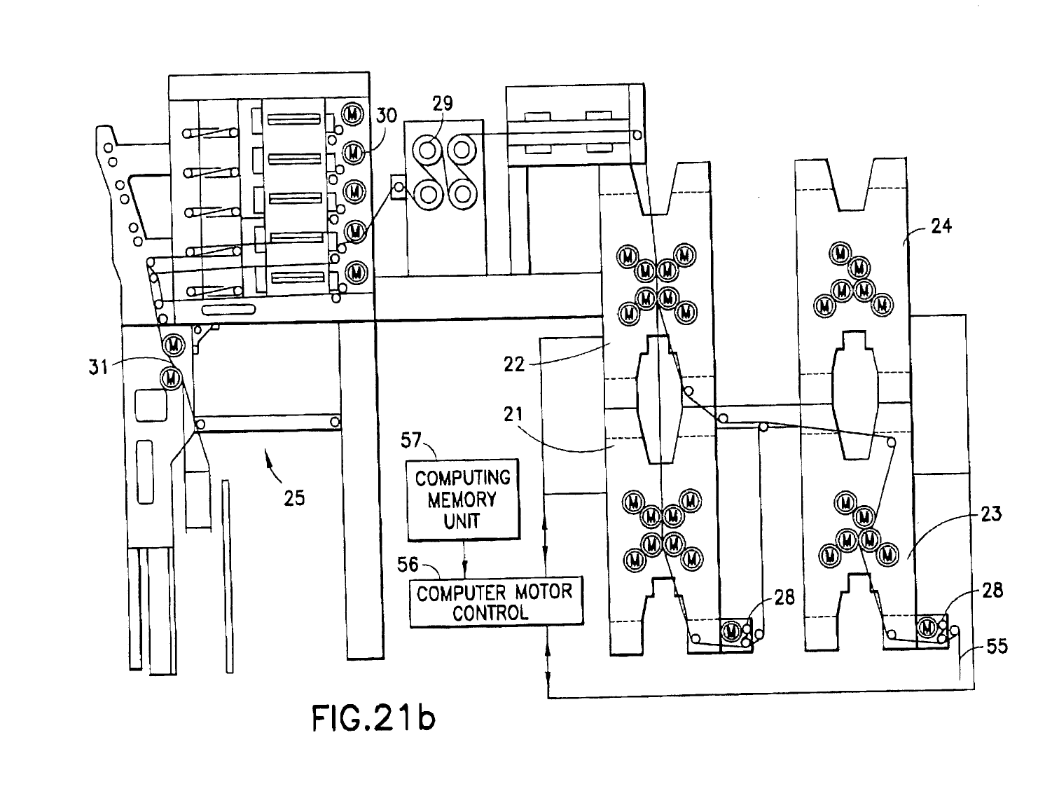

FIGS. 21 and 21.1 A printing machine with functional groups;

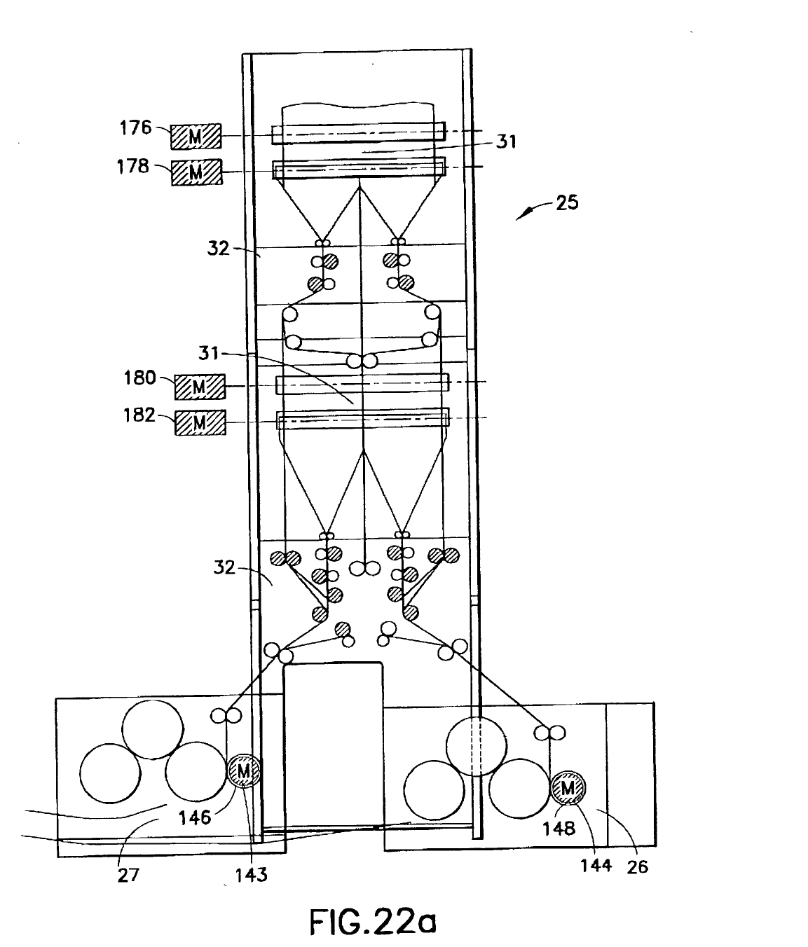

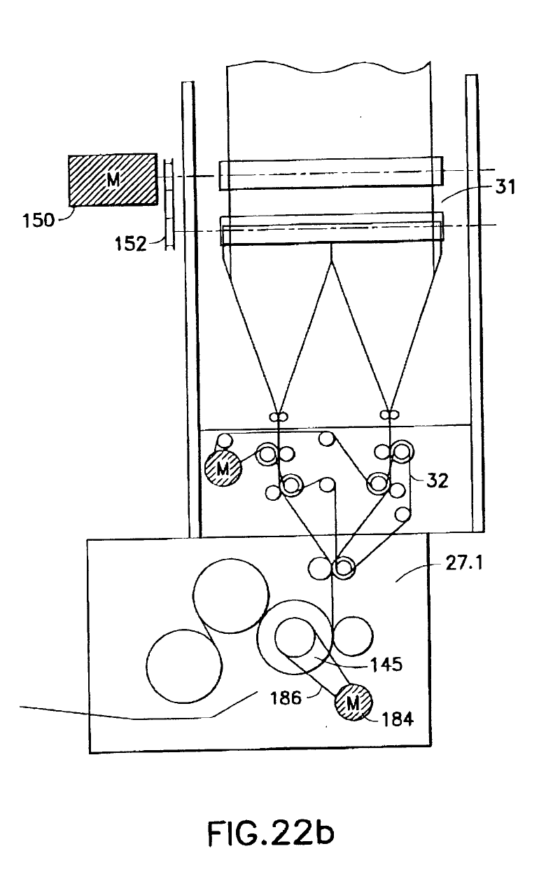

FIGS. 22 and 22.1 In each case: a folder unit with functional groups;

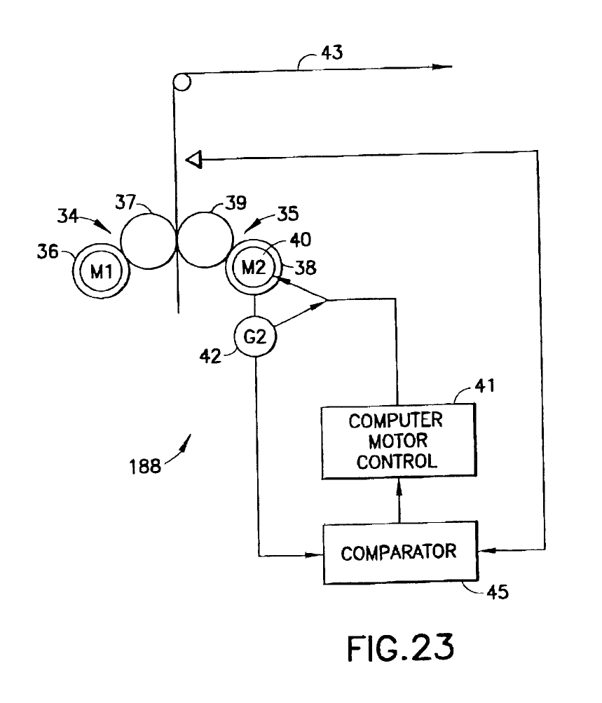

FIG. 23 A device for ink register adjustment of printing forms of a form cylinder;

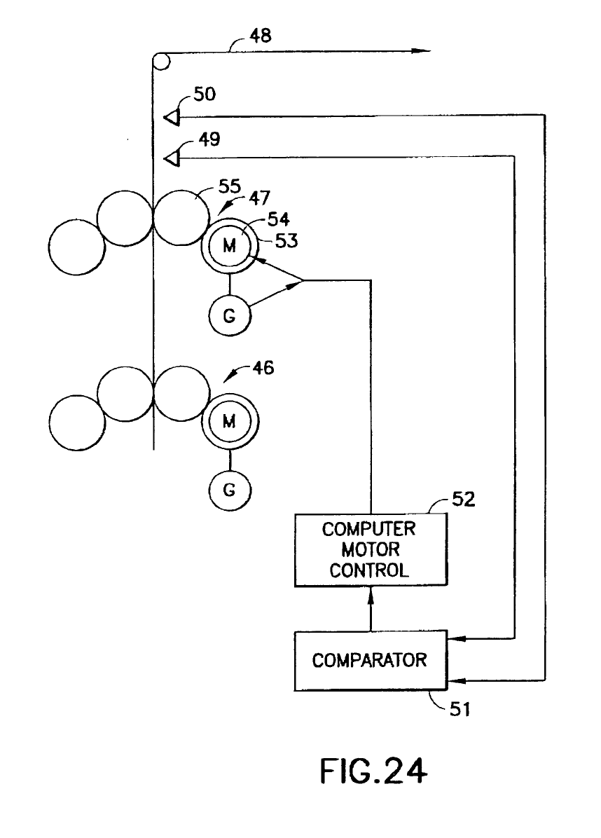

FIG. 24 A device for ink register adjustment from printing site to printing site;

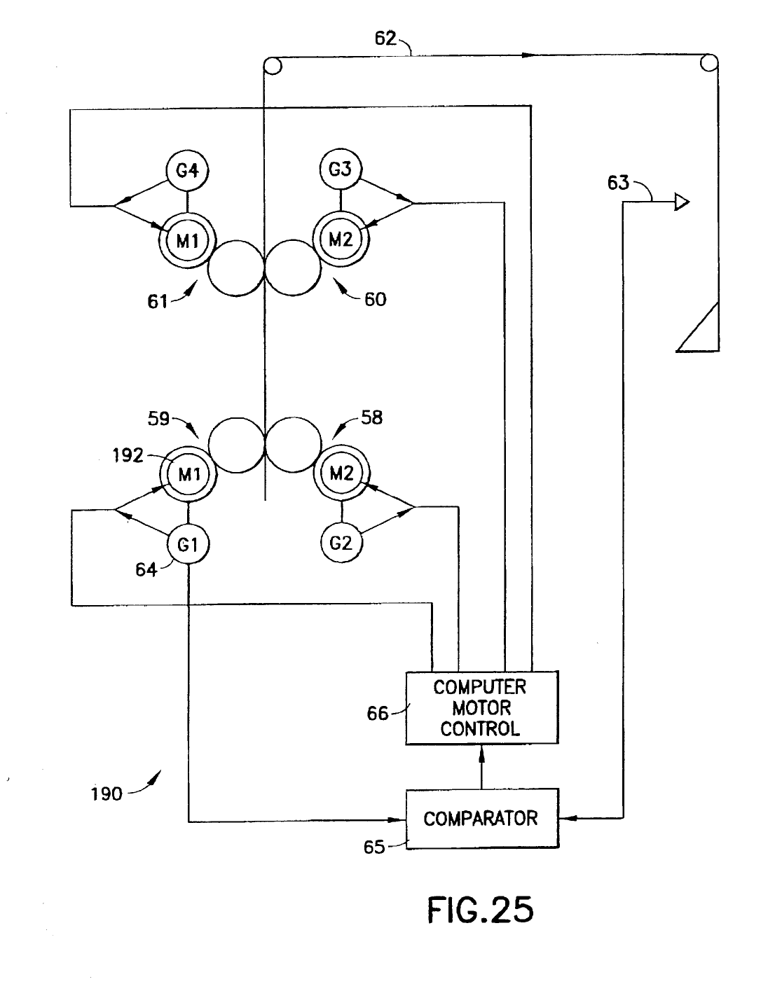

FIG. 25 A device for cutting register adjustment;

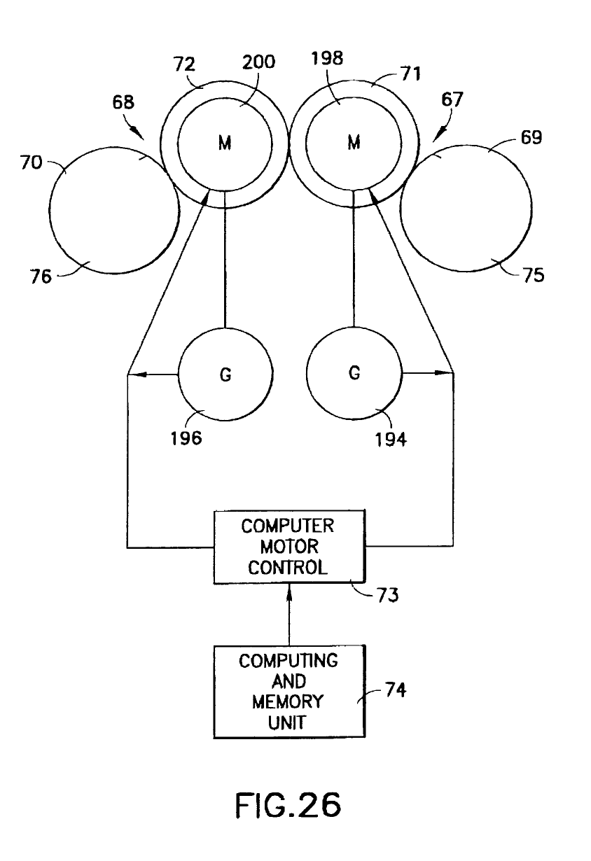

FIG. 26 A device for setting the plate changing position;

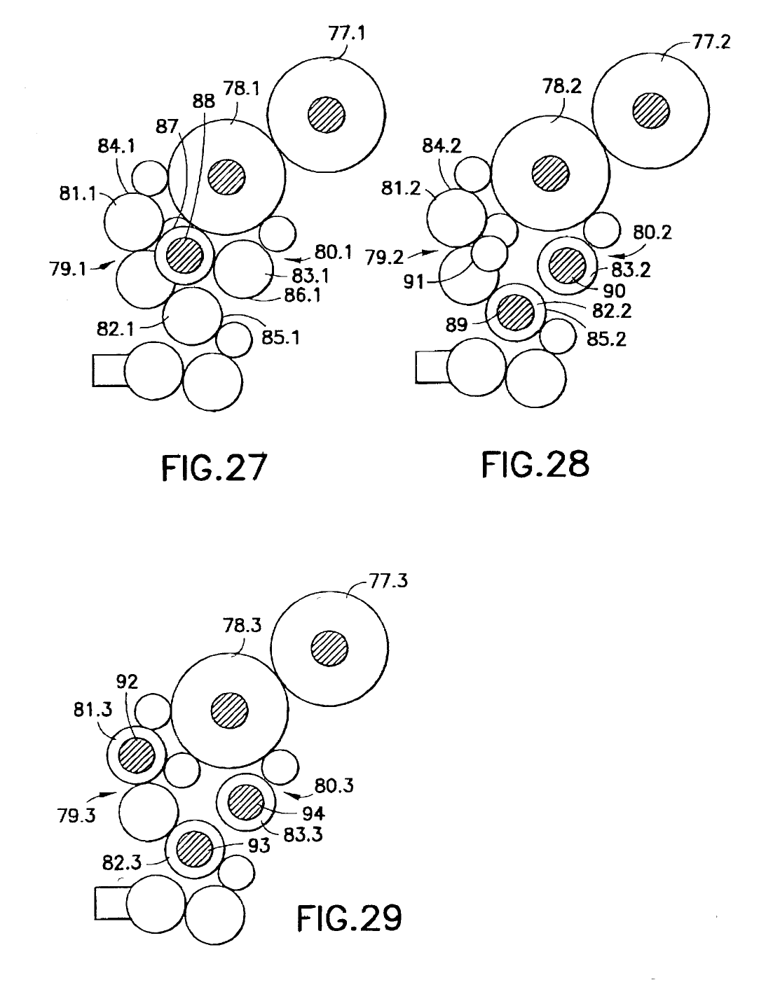

FIG. 27 The drive of an inking and damping unit, in side view;

FIG. 28 A further variant of the drive of an inking and damping unit;

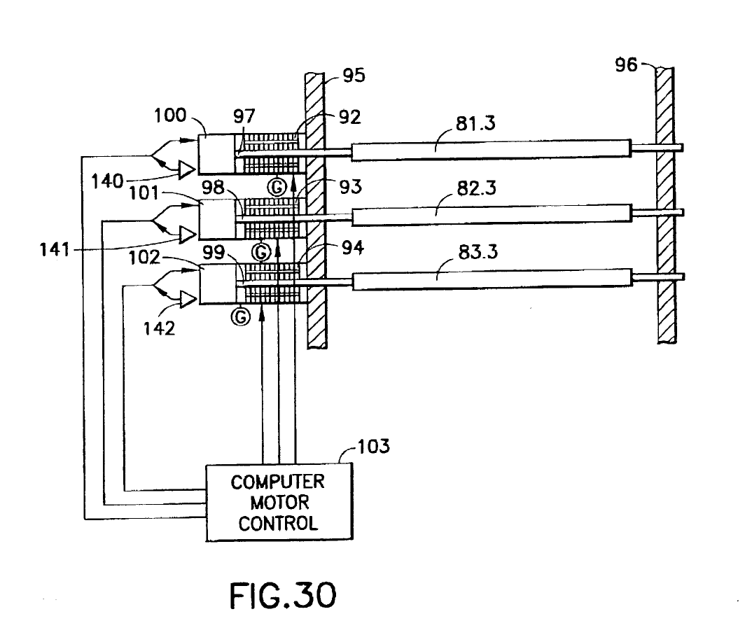

FIG. 30 A view of the distribution cylinder from FIG. 29;

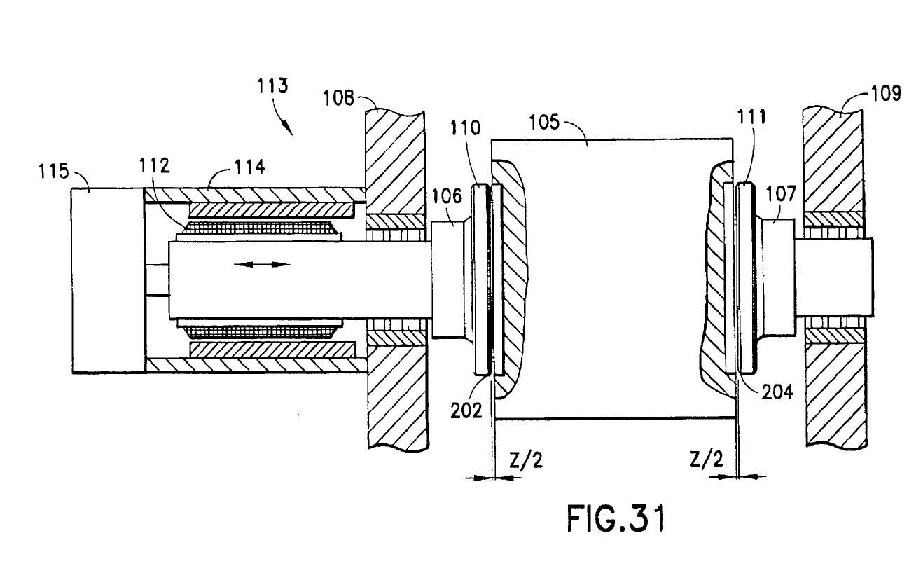

FIG. 31 An arrangement of an electric motor on a form cylinder;

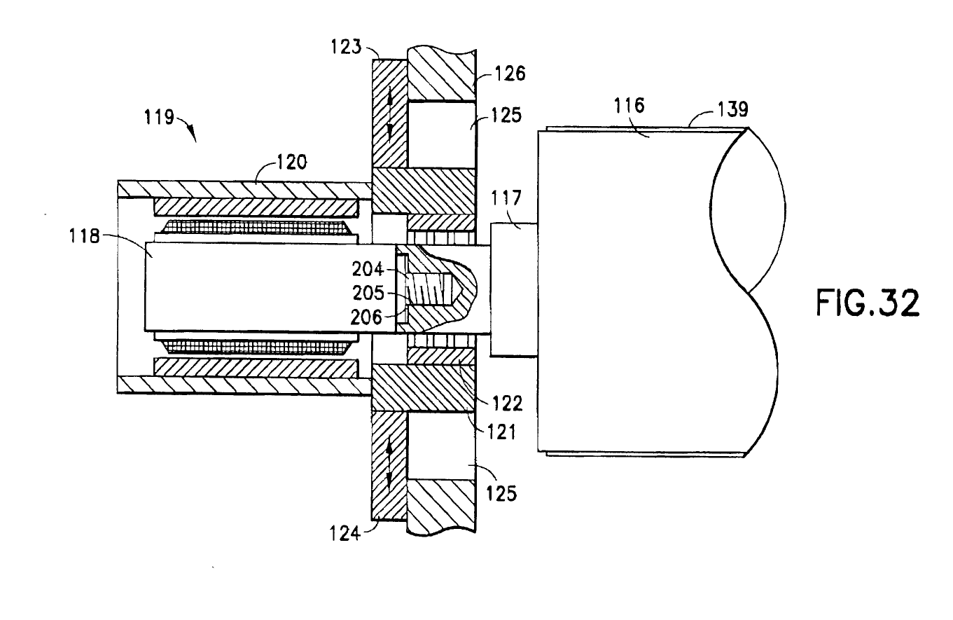

FIG. 32 A further variant of the arrangement of an electric motor;

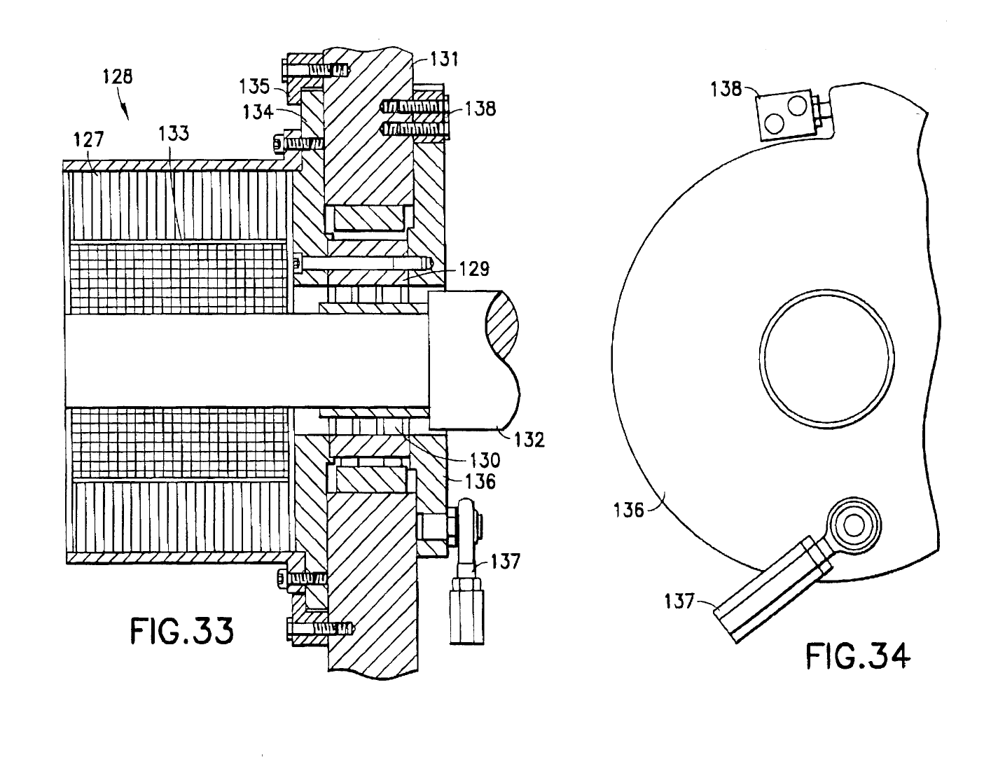

FIG. 33 A third variant of the arrangement of an electric motor;

FIG. 34 View Y from FIG. 33.

FIGS. 1 to 4 show printing units, each of which is driven by a separate, angle-controlled electric motor. In FIG. 1, the printing unit contains two printing groups 3, 4, each of which is formed by a form cylinder 1.1, 1.2 and a transfer cylinder 2.1, 2.2. Each form cylinder and each transfer cylinder 1.1, 1.2, 2.1, 2.2 is mounted by its journals in side walls 5, 6 (FIG. 5). An angle-controlled electric motor 7, which drives the form cylinder 1.1, is arranged on the operator-side side wall 5. The design of this drive connection will be discussed below. The journals mounted in the side wall 6, carry the respective spur gears 8 to 11, with which the cylinders 1.1, 1.2, 2.1, 2.2 are in drive connection with the respective adjacent cylinders. In this way, all four cylinders are driven by the electric motor 7 (represented in FIG. 1 by hatching).

In FIG. 2, the printing unit shown in FIG. 1 is supplemented by the printing group 12 with the form cylinder 1.3 and the transfer cylinder 2.3. The printing group 12 is set on the printing group 4, whereby (not shown) the drive-side journals also carry spur gears and the spur gear of the transfer cylinder 2.3 engages with the spur gear 11 of the transfer cylinder 2.2.

Via these spur gears 8 to 11, all cylinders are thus in drive connection with the form cylinder 1.1, and are driven by the electric motor 7.

In FIG. 3, the printing groups 3, 4 as in FIG. 1 are supplemented by the coupled printing groups 13, 14 with the form cylinders 1.4, 1.5 and the transfer cylinders 2.4, 2.5. In a manner not shown, each drive-side journal of the cylinders 1.4, 1.5, 2.4, 2.5 carries a spur gear, with which the cylinders are engaged among themselves. Furthermore, the spur gear 11 of the transfer cylinder 2.2 is in drive connection via a gear chain 15 with the spur gear of the transfer cylinder 2.5, so that all cylinders are driven by the electric motor 7.

In contrast to FIG. 3, the printing unit in FIG. 4 is supplemented by a satellite cylinder 16. The satellite cylinder 16 carries a spur gear on the drive-side journal (not shown). This spur gear, as well as the spur gear of the form cylinder 1.4, is driven by a gear chain 17, which starts from the spur gear 8 of the form cylinder 1.1, so that all cylinders of the printing unit are driven by the electric motor 7.

For the sake of simplicity, the item numbers used in FIGS. 1 to 5 are used again in FIGS. 6 to 20 for recurring spatial arrangements of cylinders and printing groups, regardless of any structural differences. FIGS. 6, 7 and 10 show bridges, i.e., parts of printing units, which correspond to the printing units shown in FIGS. 1, 2 and 5 and are therefore not described again in detail.

In FIG. 8, the gear chain 15 shown in FIG. 3 is omitted. The lower printing group bridge (double printing group) which is created, which has the form cylinders 1.1 and 1.2 and the transfer cylinders 2.1 and 2.2, is driven in the same manner as in FIGS. 6 and 7. The upper printing work bridge which is created, which has the form cylinders 1.4, 1.5 and the transfer cylinders 2.4, 2.5, is driven by an angle-controlled electric motor 7, which acts upon the form cylinder 1.4. Via spur gears (not shown) on the journals of the cylinders 1.4, 2.4, 2.5, 1.5, the form cylinder 1.4 drives these cylinders.

In FIG. 9, the situation is similar to FIG. 8. The only difference is that a satellite cylinder 16 is also driven by the form cylinder 1.1 by means of the gear chain 18. Printing group bridges of the types shown in FIGS. 6 to 9 or of different types may be combined into various printing units. The drive cases described below can thereby also be used.

In the above examples, it is also possible for every other form cylinder or transfer cylinder, or for the satellite cylinder, to be driven by the electric motor.

The double printing group shown in FIG. 11 contains the printing groups 3, 4 with, respectively, the form cylinders 1.1, 1.2 and the transfer cylinders 2.1, 2.2. These cylinders are also mounted in side walls 5, 6 (FIG. 15), as in FIGS. 1 and 6. However, each printing group 3, 4 is driven by its own angle-controlled electric motor 7; specifically, the respective form cylinders 1.1 and 1.2 are driven. The drive-side journals of the form cylinders 1.1, 1.2 carry the respective spur gears 8, 19, which mesh with-the respective spur gears 10, 20 on the journals of the transfer cylinders 2.2, 2.2. The spur gears 8, 10 and 19, 20 lie on two different planes, since the transfer cylinders 2.1, 2.2 are not permitted to be in drive connection with one another. An angle-controlled electric motor acts upon the respective operator-side journals of the form cylinders 1.1, 1.2 and drives the printing groups 3, 4.

In the previous examples and in those that follow, the electric motors drive the form cylinders. Alternately, it is also possible for the transfer cylinders to be driven. For example, in the printing unit shown in FIG. 12, the electric motors 7 drive the respective transfer cylinders 2.1, 2.2, 2.3 of the printing groups 3, 4, 12. These transfer cylinders then drive, by means of spur gears, the respective associated form cylinders 1.1, 1.2, 1.3. As in FIG. 15, the spur gears of the printing group 4 and the printing group 3 are not permitted to lie on the same plane, nor are the spur gears of the printing groups 4 and 12.

In the printing unit in FIG. 13, each of the form cylinders 1.1, 12, 1.4, 1.5 of the printing groups 3, 4, 13, 14 is driven by an angle-controlled electric motor 7. These form cylinders then drive, by means of spur gears, the respective associated transfer cylinders 2.1, 2.2, 2.4, 2.5. The respective spur gears of coupled printing groups lie on two different planes.

In FIG. 14, the printing groups 3, 4, 13, 14 are driven analogously to FIG. 13. In addition, the satellite cylinder 16 is driven by a separate, angle-controlled electric motor 7.

In the printing units in FIGS. 16 to 19, each form cylinder 1.1 to 1.5 and each transfer cylinder 2.1 to 2.5 as well as the satellite cylinder 16, if present, is driven by a separate, angle-controlled electric motor 7. As in the previous examples, the bearing of the cylinders is in the side walls 5, 6. In contrast to the previous examples, however, the respective electric motors 7 are arranged on the journals on the so-called “drive side” S2 (FIG. 20). The electric motors could just as well be located on the operator-side journals. Furthermore, in the prior examples, the electric motors could have been located on the drive-side journals as well. When each printing group is equipped with its own drive motor (FIGS. 11 to 14), the individual printing groups can be driven in a manner well-adjusted and another in a manner correct for unwinding. When there is a separate drive for each cylinder (FIGS. 16 to 19), it is even possible to have unwinding-correct driving between the form cylinder and transfer cylinders 1, 2 of one printing group. In addition, all toothed-wheel gears are dispensed with, as are the lubrication, housings, etc., usually required for these, resulting in tremendous cost savings. In addition, mechanical (and electrical) devices for the desired printing group control are dispensed with, because this is performed by reversing the rotational direction of the drive motors.

In the examples, a printing group always includes a form cylinder and a transfer cylinder and works together with another such printing group according to the blanket-to-blanket principle, or with a satellite cylinder. A printing group of this sort can also be enlarged by a counter impression cylinder into a three-cylinder printing group, whereby each cylinder is driven by a separate electric motor, or only one cylinder is driven by an electric motor and the three cylinders are in drive connection via toothed gears.

The angle control of the electric motors is carried out by means of computer motor controls in the framework of the machine control system. Accordingly, the motors are connected to these systems. However, the controls are not part of the subject matter of the invention and are therefore not depicted or explained here.

Further functional groups of printing machines can also be advantageously driven with separate electric motors. FIG. 21 shows a printing machine (side view) and FIG. 22 shows a folder unit with functional groups of this type. The printing machine in FIG. 21 contains four printing units 21 to 24 and a folder unit 25. In respect to drive, the printing units 23 and 24 resemble the printing unit shown in FIG. 17, while the printing units 21 and 22 resemble that shown in FIG. 18. The drive motors of the cylinders, like those of the functional groups described below, are identified by an “M” or with hatching. The folder unit shown in FIG. 22 contains the folding mechanisms 26 and 27. In FIG. 21, the webbing-in mechanisms 28, the cooling rollers 29, the cutting rollers 30 and the forming rollers 31 are driven, respectively, by the separate, angle-controlled electric motors 33.1 to 33.5. The electric motors thereby drive the cylinders of these functional groups indirectly via belts. FIG. 22.1 shows the same printing machine, with each cylinder of these functional groups being driven directly by a motor.

In FIG. 22, the forming rollers 31 and the feeding and transfer rollers 32, respectively, are driven directly by separate, angle-controlled electric motors. The two folding mechanisms 26 and 27, respectively, also have separate, angle-controlled motors, which directly drive the respective folding cylinders, in this case, the knife cylinders 143, 144. The other folding cylinders are engaged with this knife cylinder via spur gears arranged on their journals.

In the folder unit in FIG. 22.1, the forming rollers 31 and the feeding and transfer rollers 32, respectively, are driven indirectly by a shared motor via a toothed belt. The single folding mechanism 27.1 is also driven by a separate, angle-controlled electric motor. The drive is carried out indirectly by means of belt drive on, for example, the point-folding blade cylinder 145. This cylinder is in drive connection to the other folding cylinders with their cylindrical gears. These electric motors make it possible to sensitively set the speed of the driven cylinders. In groups with advance control, correspondingly sensitive setting of web tension is also possible. Furthermore, great cost advantages result from the omission of the PIV gears normally used for drives of this type in the past.

The separate electric motor which directly drives a form cylinder can also advantageously be used as an adjusting element for the ink register adjustment. FIG. 23 shows a device for ink register adjustment in a double printing group with the printing groups 34 and 35, which contain, respectively, the form cylinders 36, 38 and transfer cylinders 37, 39. The device is described in reference to the form cylinder 38, which carries two printing forms on its circumference. The electric motor 40 which drives the form cylinder 38 is angle-controlled by a computer motor control 41. Furthermore, a position indicator 42 of the printing group 35 and a sensor 44 which scans the register marks on the web 43 leaving the printing group 35 are connected to a comparison device 45, the output of which is fed to the input of the computer motor control 41. The sensor 44 scans the register marks printed by the printing group 35 on the web 43 and thus detects the position of the two images printed per rotation of the form cylinder. Using the signal of the position indicator 42, the relation to the rotation of the form cylinder 38 is established in the comparison device 45. When a printing image is arranged staggered in the rotational direction by half the circumference of the form cylinder, i.e., when the printing image is arranged so as to deviate by half the circumference, the form cylinder 38 is operated with a compensating advance or lag prior to printing in this area. This is done by the computer motor control based on the output signal of the comparison device 45. In this way, for example, copying errors or mounting errors of the printing form can be compensated for. If certain compromises in register quality are accepted at the beginning of printing, it is also possible to extend the acceleration or delay phase into this area, allowing the electric motor to be designed with lower power.

The device shown in FIG. 24 serves to control the circumferential register between two printing sites, in this case, between the printing groups 46 and 47. The register marks printed by these printing groups 46, 47 on the web 48 are scanned by the sensors 49, 50. Signals from the sensors 49, 50 are supplied to the comparison device 51. The comparison device 51 furnishes the comparison results to the computer motor control 52. The computer motor control 52 regulates the speed of the electric motor 54, which drives the form cylinder 53 of the printing group 47. Depending on the required register modification to the printing image of the printing group 46, the electric motor 54 is operated with an advance or a lag. If the transfer cylinder 55 is also driven by a separate electric motor, this motor, too, is advantageously corrected in respect to speed when there is a register correction. In keeping with the number of the register marks to be checked, the device is to be used multiple times or fully expanded, as appropriate. This device makes it possible to save the costs of traditional, expensive mechanical gears, e.g., sliding gears, for the circumferential register adjustment of the form cylinder.

Thanks to the single drive of the printing groups, it is also possible for different paper paths to be travelled between different printing units without additional devices for length regulation being necessary. For example, in the printing machine in FIG. 21, the web 55 can be conducted from the printing unit 23 either to the printing unit 21 or, on the path shown by the broken line, to the printing unit 22. In keeping with the different paths, the printing groups of the printing units 21 and 22 are moved into the required positions by means of their drive motors. For this purpose, the computer motor control 56 of the electric motors is connected on the input side to a computing and memory unit 57, in which the required cylinder positions are stored. Depending on the web course, these positions are given to the computer motor control 56, which moves the form cylinders and transfer cylinders into the required positions by controlling their electric motors accordingly.

In addition, the computing and memory unit 57 stores, for the possible web courses, the cylinder positions of the printing groups for the cutting register. To set the cutting register in keeping with the selected production configuration, the required cylinder positions are given to the computer motor control 56. In keeping with the presetting, the computer motor control 56 adjusts the drive motors of all printing groups printing the web 55. The cutting register for the cut in the folding mechanism is thus set via the cylinder positions of all printing groups participating in printing. In this way, the expensive linear register devices usual until now are dispensed with. Only for the turning [bar] is length regulation of this type still required. The computing and memory unit which stores the cylinder positions for the cutting register can also be fed to the computer motor control 66 of the device shown in FIG. 25 and described below, whereby this device then serves both to control the cutting register and to adjust it.

Thanks to the separate drives of the printing groups, it is also possible for groups of printing machines to be assembled in variable fashion without using with the previously standard connecting elements, such as synchronous shafts, couplings, gears and positioning devices. By means of a suitable control program, it is possible for the printing units 21, 22, 23 connected to the folder unit 25 in FIG. 21, or for some of these printing units, to also be associated with a different folder unit, not shown.

FIG. 25 shows a device for cutting register control. The printing groups 58 to 61 are printing on a web 62, for example. A sensor 63 scans a register mark that is also being printed. The sensor 63 and the position indicator 64 of an electric motor of a run-through printing unit, advantageously the first run-through printing unit 59, are attached to the inputs of a comparison device 65, which is connected on its output side to the input of the computer motor control of the electric motors of the printing groups 58 to 61. A register error detected in the comparison device 65 is compensated for by the advanced or lagged drive of the printing groups 58 to 61 printing the web 62, accomplished through corresponding control of their electric motors by means of the computer motor control 66.

FIG. 26 shows a device used to move the form cylinder into a position suitable for a form change. The printing unit in the example contains two printing groups 67, 68 with the respective form cylinders 69, 70 and transfer cylinders 71, 72. The drive motors of the printing groups 67, 68, which here drive the transfer cylinders 71, 72, for example, are connected to a computer motor control 73, which is fed by a computing and memory unit 74. The cylinder positions of the form cylinders 69, 70 required for a printing-forms changed are stored in the computing and memory unit 75. These positions are given to the computer motor control 73, which controls the electric motors of the printing groups 69, 70 in such a way that the clamping cavities 75, 76 of the form cylinders 69, 70 are moved into the plate change position by the shortest path. As in the previous examples, it does not matter whether the transfer cylinder or the form cylinder or both cylinders in a printing group are driven. With the help of this device, it is possible to dispense with the previously usual timeconsuning individual disengagement of the printing groups, the subsequent positioning of the printing groups, and their re-engagement after the printing form change.

Advantageously, the distribution cylinders of inking and damping units are also driven by separate drives. FIG. 27 shows a printing group with a transfer cylinder 77.1 and a form cylinder 78.1, whereby an inking unit 79.1 and a damping unit 89.1 are arranged on the latter. The inking unit 79.1 contains, among other items, the ink distribution cylinders 81.1 and 82.1, and the damping unit 80.1 contains the damping distribution cylinder 83.1. Each distribution cylinder 81.1, 82.1, 83.1 carries a spur gear 84.1, 85.1, 86.1, all of which are engaged with a central gear 87. The central gear 87 is driven by an angle-controlled electric motor 88. In the example, the central gear 87, not shown, is located on the rotor journal of the electric motor 88. The electric motor could also be arranged next to the central gear 87 and engage into it with a pinion. The electric motor 88 thus drives both of the inking distribution cylinders 81.1, 82.1 and the damping distribution cylinder 83.1.

In FIG. 28, the inking distribution cylinders 81.2 and 82.2 are driven by an angle-controlled electric motor 89. The damping distribution cylinder 83.2 of the damping unit 80.2 is driven by an angle-controlled electric motor 90. The electric motor 89 directly drives the inking distribution cylinder 82.2. The latter carries a spur gear 85.2, with which it drives, via an intermediate gear 91, a spur gear 84.2 of the inking distribution cylinder 81.2.

FIG. 29 shows a drive variant in which each inking distribution cylinder 81.3, 82.3 of the inking unit 79.3, as well as the damping distribution cylinder 83.3 of the damping unit 80.3, is driven by a separate, angle-controlled electric motor 92, 93, 94. In this drive of the inking and damping unit, all of the toothed gears previously usual for this are dispensed with.

Along with the advantage of being able to regulate the speed of the inking distribution cylinder during driving by means of separate, angle-controlled electric motors, the lateral distribution can also be advantageously designed. FIG. 30 shows a side view of the inking and damping distribution cylinders 81.3, 82.3, 83.3, which are mounted in the side walls 95, 96. The respective linear motors 100 to 102, for example, act on the journal 97 to 99 of these cylinders 81.3 to 83.3, which are advantageously designed as rotors of the driving electric motors 92 to 94. The angle-controlled electric motors 92 to 94 are controlled by a computer motor control 103. The motor control 103 advantageously controls the linear motors 100 to 102 with a like sequence of motions. There is advantageously a sine-shaped curve of the oscillating motion, whereby the distributor lifts are staggered to one another by 1200 in the phase position. In this way, a mass balance is achieved, which stops vibrations from being stimulated at a right angle to the machine axis. The target value of the axial stroke is advantageously established in a selectable manner. The instantaneous position of the ink distributors 81.3, 82.3, 83.3 is fed back to the motor control by the sensors 140 to 142. In addition, the design of the oscillating speed linearally proportional to the speed of the printing machine is also advantageous.

In order to achieve an exact drive of the cylinders, it is important for their coupling to the electric motor to be as rigid as possible. Structural examples of this are provided below. FIG. 31 shows a form cylinder 105, which is mounted by its journals 106, 107 in the side walls 108, 109 of the printing machine. The journals 106, 107 carry flanges 110, 111, with which they are screwed to the faces of the cylinder body. The journal 106 is designed as the rotor 112 of the electric motor 113 driving the form cylinder, i.e., it carries on its extended end the components of the rotor. The stator 114 is attached to the side wall 108. Furthermore, a device for laterally moving the form cylinder 105 for side register adjustment acts upon the journal 106. For example, a linear motor 115 is used here for this purpose. It would also be possible to use, for example, a motor connected to a gear which transforms its rotational motion into a straight-lined movement. The shift amount Z of the side register is thereby designed in such a way that when the journals 106, 107 move away from the form cylinder body by Z/2 on both sides, the cylinder body is uncovered and can be removed from the printing machine. A sleeve-type printing form on the form cylinder 105 can then be changed. Distribution cylinders can also be similarly designed, whereby the distributor lift can be used for uncovering the cylinder body of the distribution cylinder.

FIG. 32 shows the drive-side part of a form cylinder 116, on the journal 117 of which the rotor 118 of an electric motor 119 is screwed on the face. The stator 120 of the electric motor 119, together with a bushing which is connected to it and contains the bearing 122 of the form cylinder 116, is held in the bearing shields 123, 124. The bearing shields 123, 124 can be moved apart from one another and, in their moved-apart position, uncover an opening 125 in the side wall 126 of the printing machine. A sleeve-type printing form 139 can then be passed through the uncovered opening 125 and be placed on or removed from the form cylinder 116. The contour of the printing form 139 being passed through is shown by the dot-dashed lines. Solutions for the design and actuation of the bearing shields 123, 124 as well as for holding the form cylinder 116 by its other end suspended at the uncovered opening 125 are offered by the prior art and will therefore not be discussed further. It is also possible for a transfer cylinder to be uncovered, and the motor design can be used with transfer cylinders and other cylinders of printing machines alike. In the depicted design options, it is also advantageous that independent preassembly of the rotor and stator of the electric motor can be carried out.

FIG. 33 shows the connection of the stator 127 of an electric motor 128 to the eccentric ring 129 of a three-ring bearing 130 of a cylinder mounted in the side wall 131. This can be, for example, a transfer cylinder, of which only the journal 132 is shown. By turning the eccentric bearing ring 129, for example, print engagement or disengagement is possible. This connection of the stator 127 advantageously permits its co-travel during the engagement and disengagement movement of the journal together with the rotor 133 attached to it. In particular, the stator 127 is connected to a flange 134, which is screwed to the bearing ring 129. The flange 134 is axially fixed on the side wall 131 by hold-down devices 135 and absorbs the tilting moment from the weight of the stator. The activation of the bearing ring 129 is shown in FIG. 34. The bearing ring 129 carries a nave 136, which is acted on by the print engagement and disengagement mechanism, for example, a lever 137. In the print engagement setting, the bearing ring 129 advantageously strikes a stationary and advantageously adjustable stop 138 and thus absorbs, given the corresponding rotational direction of the cylinder, the counter-moment of the stator 127. When the cylinder rotates in the other direction, the sturdily designed print engagement and disengagement mechanism absorbs the counter-moment. Advantageously, the cylinder bearing is designed free of play.

In the examples, angle-controlled electric motors are used to drive the cylinders and the functional groups. With the invention, it is also possible to use speed-controlled or moment-controlled electric motors in cases of drives in which overly great requirements are not placed on synchronism, such as the drive of web-pulling components and distribution cylinders. The computer motor controls can also be realized using other motor controls, depending on the individual case.

1. Offset printing machine with at least one printing unit with at least one form cylinder and one transfer cylinder as well as with at least one folder unit and one drive, characterized by the fact that, per printing unit, at least one of these cylinders is in drive connection with a separate electric motor (7) and this cylinder (1.1 to 1.5; 2.1 to 2.5) is not in mechanical drive connection with an optional further cylinder (1.1. to 1.5; 2.1 to 2.5), which is driven directly or indirectly by a separate electric motor.

2. Offset printing machine as in claim 1, characterized by the fact that in a printing unit with multiple commonly-acting printing groups (3, 4, 12, 13, 14), a form cylinder or transfer cylinder (1.1 to 1.5; 2.1 to 2.5) is driven by an electric motor (7) and this cylinder is in drive connection via spur gears (8 to 11, 15, 17) with the further form cylinders and transfer cylinders (1.1, to 1.5; 2.1 to 2.5) and optionally with a satellite cylinder (16).

3. Offset printing machine as in claim 1, characterized by the fact that in a printing group bridge of a printing unit, a form cylinder or transfer cylinder (1.1 to 1.5; 2.1 to 2.5) is driven by an electric motor (7) and this cylinder (1.1 to 1.5; 2.1 to 2.5) is in drive connection via spur gears (8 to 11) with the further form cylinders and transfer cylinders (1.1 to 1.5; 2.1 to 2.5) of this printing group bridge and optionally with a satellite cylinder (16).

4. Offset printing machine as in claim 1, characterized by the fact that in a printing unit, each of the form cylinders (1.1 to 1.5) is driven, respectively, by a separate electric motor (7) and is in drive connection via spur gears (8, 10, 19, 20) with the respective associated transfer cylinder (2.1 to 2.5).

5. Offset printing machine as in claim 1, characterized by the fact that in a printing unit, each of the transfer cylinders (2.1 to 2.5) is driven, respectively, by a separate electric motor (7) and is in drive connection via spur gears (8, 10, 19, 20) with the respective associated form cylinder (1.1 to 1.5).

6. Offset printing machine as in claim 1, characterized by the fact that all form cylinders and transfer cylinders (1.1 to 1.5; 2.1 to 2.5) and, as applicable, the satellite cylinder (16) are driven, respectively, by separate electric motors (7).

7. Offset printing machine, especially as in one of the above claims, characterized by the fact that functional groups, especially webbing-in mechanisms (28), cooling rollers (29), cylinders in the folder unit mechanism (26, 27), as well as groups with advance control, such as cutting rollers (30) before the turning bars, forming rollers (31) in the folder unit device, and feeding and transfer rollers (32), are directly or indirectly driven, respectively, by separate electric motors (33).

8. Offset printing machine, especially as in one of the claims 4 to 6, characterized by the fact that for the purpose of adjusting the ink register, the electric motor (7) which drives the form cylinder (1.1 to 1.5) to be adjusted functions as an adjusting element.

9. Offset printing machine, especially as in one of the claims 4 to 6 or 8, characterized by the fact that for the purpose of adjusting the circumferential register of multiple printing images relative to one another on the circumference of a form cylinder (38) of a printing group (35), a position indicator (42) of the printing group (35) and a sensor (44), which scans the register marks on the web (43) leaving the printing group (35), are connected to a comparison device (45), the output of which is fed to the input of the motor control (41) of the electric motor or electric motors (40) of the printing group (35) for their periodic driving with the required advance or lag per rotation.

10. Offset printing machine, especially as in one of the claims 4 to 6 or 8, characterized by the fact that for the purpose of adjusting the ink register between two printing groups (46, 47) which print on the web (48) one after the other, two sensors (49, 50), which scan the register marks on the web (4) leaving the printing groups, are connected to a comparison device (51), the output on which is fed to the input of the motor control (52) of the electric motor or electric motors (54) of the printing group (47) to be adjusted.

11. Offset printing machine, especially as in one of the above claims, characterized by the fact that for the purpose of presetting the printing units (21 to 24) in order to match different web paths, the motor control[s] (56) of the electric motors of the printing groups to be adjusted are connected on the input-side to a computing and memory unit (57), into which the cylinder positions to be established are entered.

12. Offset printing machine, especially as in one of the above claims, characterized by the fact that for the purpose of controlling the cutting register of a web (62) which is printed on by at least one printing group, a sensor (63) for the cutting register and a position indicator (64) of an electric motor of one of the printing groups (58 to 61) printing on the web (62) are connected to a comparison device (65), the output of which is fed to the input of the motor control (66) of the electric motor or electric motors of the printing groups (58 to 61) printing on the web (62) for their advanced or lagging drive to their required positions.

13. Offset printing machine, especially as in one of the claims 4 to 6, characterized by the fact that for the purpose of turning the form cylinders (75, 76) into a position for the form change, the motor controls (73) of the electric motors which drive the form cylinders (75, 76) are connected on the input-side to a computing and memory unit (74), into which the cylinder positions to be established are entered.

14. Offset printing machine, especially as in one of the above claims, characterized by the fact that all inking and damping distribution cylinders (81.1, 82.1, 83.1) of an inking unit and a damping unit (79.1, 80.1) are commonly driven by one electric motor (88).

15. Offset printing machine, especially as in one of the claims 1 to 13, characterized by the fact that all inking distribution cylinders (81.2, 82.2) of an inking unit (79.2) are driven by a common electric motor (89) and the damping distribution cylinder (83.2) is driven by a separate electric motor (90).

16. Offset printing machine, especially as in one of the claims 1 to 13, characterized by the fact that all inking distribution cylinders and damping distribution cylinders (81.3, 82.3, 83.3) of a printing group are driven, respectively, by separate electric motors (92, 93, 94).

17. Offset printing machine as in one of the above claims with a cylinder, especially a form cylinder, transfer cylinder or distribution cylinder, characterized by the fact that the rotor (112, 118) of the electric motor (113, 119) is rigidly connected to the cylinder (105, 116).

18. Offset printing machine as in claim 17, characterized by the fact that the rotor (118) is screwed on the face to a journal (117) of the cylinder (116).

19. Offset printing machine as in claim 17, characterized by the fact that the journals (106, 107) of the cylinder (105) are screwed on the face to the cylinder body and the end of a journal (106) is designed as a rotor (112).

20. Offset printing machine, especially as in one of the claims 17 to 19, with a form cylinder, characterized by the fact that a motor (115) acts upon a journal (106) for the side register adjustment.

21. Offset printing machine, especially as in one of the claims 16 to 19, with a distribution cylinder, characterized by the fact that a motor (100, 101, 102) acts upon a journal for the lateral distribution.

22. Offset printing machine with an inking unit and a damping unit with three distribution cylinders, especially as in one of the claims 16 to 21, characterized by the fact that a motor (100, 101, 102) acts upon each distribution cylinder (81.2, 82.3, 83.3) for the purpose of its axial shifting and the motors (100, 101, 102) are controlled by a motor control (103) with the following parameters:
same sequence of motion of the three distribution cylinders
sine-shaped curve of the oscillation motion
oscillation motion linearly proportional to the speed of the offset printing machine
distributor lifts staggered to one another by 120° phase position

23. Offset printing machine as in one of the above claims, characterized by the fact that the stator (114) of the electric motor (113) is arranged fixedly on the side wall (108) of the printing machine.

24. Offset printing machine as in one of the claims 1 to 22, characterized by the fact that the stator (127) of the electric motor (128) is attached to an eccentric bearing ring (129) of the cylinder.

25. Offset printing machine as in claim 24, characterized by the fact that the eccentric bearing ring (129) carries a flange (134), with which it is held on the side wall (131) by means of hold-down devices (135) for the purpose of absorbing tilting moments, and the bearing ring (129) works together with a stationary stop (138).

26. Offset printing machine as in one of the claims 1 to 22, 24 or 25, characterized by the fact that the cylinder (116) is mounted by a journal (117) in bearing shields (123, 124) that can be moved apart from one another and which, when moved apart, uncover an opening (125) in the side wall (126), through which a sleeve-type printing or transfer form (139) can be passed.

27. Offset printing machine as in one of the above claims, characterized by the fact that the electric motor (7) is arranged on the operator side (S1) of the printing machine.

28. Offset printing machine as in one of the claims 1 to 25, characterized by the fact that the electric motor (7) is arranged on the drive side (S2) of the printing machine.

29. Offset printing machine or cylinder of an offset printing machine as in one of the above claims, characterized by the fact that the electric motor (7) is designed in an angle-controlled manner.

30. Offset printing machine as in claim 20 or 21, characterized by the fact that the amount of shift (Z) of the form cylinder (105) for the side register or the distributor lift of the distribution cylinder (81, 82, 83) is of such a dimension that when the journals (106, 107) unscrewed from the cylinder body of these cylinders are moved away, the cylinder body can be removed from the printing machine.

31. Offset printing machine, especially as in one of the above claims, characterized by the fact that for the purpose of setting the cutting register of a printed-on web (55), the motor control (56) of the electric motors of the printing groups printing on the web (55) is connected on the input side to a computing and memory unit (57), into which the cylinder positions for the cutting register are entered for the purpose of placing the cylinders of all printing groups printing on the web into the preestablished positions.

32. Process for adjusting the circumferential register of multiple printing images on the circumference of a form cylinder of a printing group, especially as in one of the claims 4 to 6, whereby the printing group prints register marks on the web, and the register marks are scanned by a sensor, the signals of which are compared to target value signals, and, based on the comparison signals, the electric motor which drives the form cylinder is operated periodically with the required advance or lag per rotation.

33. Process for controlling the cutting register of a web printed on by at least one printing group of an offset printing machine, especially as in one of the claims 1 to 6, whereby one printing group prints a register mark on the web, a sensor scans the register mark, the signal of the sensor is compared to a target value signal and, based on the comparison signal, all printing groups printing on the web are driven with advance or lag until they assume the required positions.

34. Process for reversing a separately-driven printing group of an offset printing machine, especially as in one of the claims 1 to 31, whereby the electric motor or electric motors driving the printing group are reversed in their rotational direction.
